(19) United States
(12) Patent Application Publication
(10) Pub. No.: US 2010/0218790 A1
(43) Pub. Date: Sep. 2, 2010

(54) DEVICE FOR CLEANING OPTICAL MEASUREMENT BODIES THAT HAVE AN AREA FOR CONTACT WITH THE SURFACE OF THE EYE

(75) Inventors: Werner REIS, Munchen (DE); Ronald Spaltmann, Grassau (DE)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: RS MEDIZINTECHNIK GMBH

(21) Appl. No.: 12/757,067

(22) Filed: Apr. 9, 2010

Related U.S. Application Data
(63) Continuation-in-part of application No. PCT/DE2008/001497, filed on Sep. 5, 2008.

(30) Foreign Application Priority Data
Oct. 11, 2007 (DE) 10 2007 048 897.3
Dec. 28, 2007 (DE) 10 2007 063 095.8

(51) Int. Cl. B08B 3/00

(52) U.S. Cl. 134/26; 134/95.2

(57) ABSTRACT

A device for cleaning optic gauges (6), which have an eye surface contact area, and in particular applanation tonometer gauges or ophthalmic contact lenses for diagnostic purposes or laser treatment is described. The device comprises: a liquid filling and emptying top-opening cleaning unit (11); one or more liquid reservoirs (1,2), connectable to the cleaning unit (11) so that fluids contained in the liquid reservoirs (1,2) can be dispensed into the cleaning unit (11); a waste water repository (3), connectable to the cleaning unit (11) so that liquid can be drained from the cleaning unit (11) into the waste water repository (3); a receptacle (5) to hold at least one optic gauge (6), that is either in a fixed position or positionable, so that an optic gauge (6) inserted into the receptacle (5) from above, eye surface contact area first, at least partially extends into the cleaning unit (11).

### CROSS-REFERENCE TO RELATED APPLICATION

This application is a Continuation-in-Part of PCT/DE/2008/001479 designating the United States for the National Phase, published Sep. 5, 2008, which claims priority from German Application Nos. 10 2007 048 897.3, filed Oct. 11, 2007 and 10 2007 063 095.8, filed on Dec. 28, 2007, the entire disclosures of which are hereby incorporated by reference.

### BACKGROUND OF THE INVENTION

1. Field of the Invention

The invention related to the field of medical technology and concerns a device for cleaning optic gauges, which have an eye surface contact area and in particular applanation tonometer gauges or ophthalmic contact lenses used for diagnostic purposes or laser treatment. The invention also concerns the method of operation of the same device.

2. Description of the Prior Art

In eye treatment (opthalmology) today different devices and instruments are used for diagnosis and laser treatment. These include replaceable and reusable optic gauges, which come into direct contact with the eye surface (in other words with the outer cornea) during treatment.

For example, this is how glaucoma is diagnosed (green star) by examining the intraocular pressure (internal pressure of the eyes). This examination comprises identifying a number of intraocular pressures throughout the day, ideally to collate a 24-hour pressure profile, which is not only able to detect the increase of intraocular pressure, but also augmented fluctuations in intraocular pressure throughout the day in the development, or the progression, of glaucoma damage. The most reliable device to determine intraocular pressure used by ophthalmologists today is the so-called applanation tonometer by Goldmann. The Goldmann applanation tonometry is typically performed on a seated patient. For this a local anaesthetic is applied to the eye. FIG. 1 illustrates the measurement of intraocular pressure on a seated patient with a Goldmann applanation tonometer. FIG. 1 shows a view where an attached, replaceable and typically reusable optic gauge (6) (tonometer gauge) can be seen on the tonometer measuring arm, which is introduced from the left-hand side into the cornea of the patient's right eye. The cornea is then flattened by the tonometer gauge (6), with the eye surface contact area facing the eye, and pressure being applied to the eyeball accordingly. The necessary forced applied to flatten the cornea is directly proportional to the intraocular pressure, according to the Imbert-Fick law. The force used to flatten the cornea is transferred to the tonometer gauge and can be captured and recorded with the appropriate display or measuring equipment.

Furthermore, optic gauges, so-called ophthalmic contact lenses, are used for diagnostic purposes and laser treatment, on the retina or choroid, for example. Prior to the treatment, a local anaesthesia is also applied to the cornea and conjunctiva of the eye, to numb the eye, before the ophthalmic contact lens' eye surface contact area is placed on the cornea. FIG. 2 shows a view of diagnostic treatment of a female patient's left eye using an ophthalmic contact lens (6). The doctor holds the ophthalmic contact lens (6) with his hand and places the eye surface contact area of the ophthalmic contact lens onto the cornea of the patient's left eye. The eye specialist can thereby closely inspect the upper eye lid for diagnostic purposes through this ophthalmic contact lens (6). Furthermore, a laser beam can be guided into the upper eye lid through the ophthalmic contact lens, for example onto the retina, so as to prevent a dangerous retinal detachment. Moreover, laser treatments are possible for leaking or diseased proliferating choroid blood vessels, such as with diabetes.

In any case, reusable optic gauges must be cleaned of tear film residues after every treatment, at any rate the optic gauges' eye surface contact area must be cleaned, as, on the one hand, these residues can affect the optic properties of the optic gauges and therefore future measurement results; and, on the other hand, pathogenic germs and other exogenous carriers of infection, or damaging substances, contained in the lachrymal fluid may be transmitted to other patients' eyes by the optic gauge.

The cleaning of such optic gauges, which presently also includes disinfection, has to date been carried out manually. Typically, the optic gauges are thoroughly cleaned with water, for 30-60 seconds, for example. Then they are disinfected in aqueous solution, such as one containing 3% hydrogen peroxide, or 70% ethanol or 60 to 70% isopropanol or 2.5% sodium hypochlorite, for some 5-10 minutes. Afterwards, the optic gauges are rinsed once again with water for approx. 10 to a maximum of 60 minutes. Finally, the optic gauges are dried with a disposable towel, so that they can be subsequently re-used or safely stored away.

The current cleaning of optic gauges by hand requires the employment of personnel and is therefore expensive, on the one hand, and, due to human shortcomings, it is not always guaranteed that the above-mentioned cleaning process is properly carried out (such as mandatory disinfection or the exposure time to a cleaning fluid exactly followed according to the respective guidelines). In particular the interruptions or distractions of personnel in everyday practice can lead to deviations from the prescribed cleaning process. Often, the correct materials are not used for cleaning (such as alcohol cloths that have no disinfectant effect), which significantly reduces the durability of softer lenses in particular. Even with the prescribed cleaning, after two years of use there is noticeable wear and tear on the surfaces of a tonometer gauge, particularly on its eye surface contact area. FIGS. 3 a and 3 b, respectively, illustrate a vertical view from above of a part of the circular eye surface contact area of a tonometer gauge. FIG. 3a shows the view of a new, unused tonometer gauge. FIG. 3b shows the view of a tonometer gauge that has been used for 2 years and at all times cleaned following the method prescribed, and dried with a disposable towel. It is clearly visible in FIG. 3b that the surfaces of the soft tonometer gauge material are frayed. This can affect both the optic properties and the measurement results, as well as causing mechanical injuries to the cornea. In addition the cleanability of the tonometer gauge deteriorates, as, for example, disinfectant or other residues become embedded in the roughened surfaces and it may be difficult to rinse them out. This fraying is caused to a great extent by the mechanical actions of drying the tonometer gauge with the disposable towel.

### SUMMARY OF THE INVENTION

The present invention relates to a cleaning device for reusable optic gauges with an eye surface contact area, particularly applanation tonometer gauges or ophthalmic contact lenses used for diagnostic or laser treatment which provides a reliable, careful and cost-efficient cleaning of optic gauges.

According to the invention, the devices for cleaning optic gauges, which have an eye surface contact area, particularly applanation tonometer gauges or ophthalmic contact lenses used for diagnostic or laser treatment, comprise at least: a top-opening, cleaning unit which can be filled and emptied of liquid; one or more liquid reservoirs, which are connected to the cleaning unit to ensure that the appropriate liquid contained in the liquid reservoirs is introduced into the cleaning unit; a waste water repository, which is connected to the cleaning unit to ensure that liquid can be drained into the waste water repository from the cleaning unit; a receptacle to hold at least one optic gauge, which is positioned, or can be positioned in such a way that an optic gauge inserted, with the eye surface contact area inserted first in the receptacle from above, will at least partially extend into the cleaning unit; one or more switches, for influencing or shutting off of the liquid being dispensed from the liquid reservoirs into the cleaning unit and/or the liquid being drained from the cleaning unit; mechanisms providing a wash cycle; mechanisms providing a drying cycle; a control unit connected to the switches, the wash and drying cycle controls. These foregoing elements can be automatic and controlled by the control unit as per a fixed pre-set or specific cleaning program.

The device according to the invention enables an automatic cleaning of at least one optic gauge in the receptacle, after typical manual application, with a fixed pre-set or variable specific cleaning program. The word “clean” is hereby interpreted widely, and comprises, depending on the liquids being used in the device, for example the disinfecting or washing as well as the subsequent drying of the optic gauge.

Prior to describing the individual component parts of the device according to the invention in detail as follows, the control of the device and its working principle are first considered.

The present invention is controlled by a control unit, which executes or implements control commands in the pre-set or pre-determinable cleaning programs. The cleaning program can be software-based and therefore, in principle, can be variable or fixedly pre-set. The cleaning program preferably defines a sequence of so-called wash and dry cycles which will be implemented by the device of the invention. The wash cycle is understood to comprise each process that entails the filling of the cleaning unit with liquid from the liquid reservoir, then the partial immersion of at least one optic gauge, with its eye surface contact area inserted first, in this liquid for the specified duration of a cleaning program, and finally the emptying of liquid from the cleaning unit. Meanwhile, the drying cycle comprises each process during a cleaning program for a specified length of time, whereby the optic gauge is no longer immersed in liquid and the optic gauge is dried which typically follows a wash cycle.

The liquids required for the cleaning program, and the wash cycles, should be placed in the device's liquid reservoirs. One especially preferential design has two liquid reservoirs, with distilled water, preferably, being added to the first liquid reservoir for washing and a disinfectant liquid being added to the second, such as 3% hydrogen peroxide solution. Naturally, the number of required liquid reservoirs depends on the number of liquids needed for the cleaning program's wash cycles. The number of liquid reservoirs is less than or equal to the number of liquids required for the cleaning program, as by mixing liquids one or more additional mixed liquids can be produced. An advantage is that the liquid reservoirs have a lid, to avoid contamination or evaporation of the liquid; they can be easily refilled and/or easily replaced. In the latter case, the liquid reservoirs can also consist of standard commercial containers, such as disinfectant or cleaning liquid holders, in which the liquids are sold. The liquid reservoirs should also consist primarily of resistant, inert materials, which will not be damaged by the liquids and will not change the liquids chemically.

The receptacle in the present invention serves to hold at least one optic gauge to be washed. Typically, the optic gauges are manually inserted or placed into the receptacle. To remove the optic gauge from the receptacle, a wide variety of noted specialist devices and mechanisms can be used. An advantage is that the receptacle is appropriate for different forms of optic gauges. Alternatively, adapters can also be provided which can be integrated with the receptacle to make them suitable for inserting different shapes of optic gauges.

The receptacle is either installed relative to the cleaning unit, or it is at least positionable so that one optic gauge can be loaded from above, with the eye surface contact area inserted first, and at least partially being immersed in the cleaning unit. In the latter case, alternatively a propulsion mechanism can be provided as an added advantage, so that the receptacle and/or the cleaning unit can be positioned relative to each other, to ensure that an optic gauge can be loaded from above, with the eye surface contact area inserted first, to at least partially extend into the cleaning unit and then be removed upwards out of the cleaning unit. The propulsion mechanism can be a mechanical, manually operated lever unit or an electric motor, particularly a linear motor.

The basic provision of at least one cleaning unit, the liquid reservoirs and a waste water repository of the device of the invention can be made in a variety of different designs. These may result from the design of the device, from mechanical data or requirements when constructing the device, etc. The simplest design of the cleaning unit is to make it rotationally symmetrical, with a funnel-shaped floor, which has an opening at its deepest point, through which the liquid from the cleaning unit can be drained. This type of cleaning unit is simple to manufacture technically and allows for optimal emptying of the liquid from the cleaning unit. Liquid from the liquid reservoirs can be introduced into the cleaning unit via inlet openings provided in the wall or floor of the cleaning unit, via liquid feed lines directly above the cleaning unit or via one or the same opening(s) through which the liquids are emptied, or a combination is also possible. In a particularly preferential design, all the surfaces in the cleaning unit that the liquid comes into contact with have a “lotus effect”.

By “lotus effect” the low wettability of a surface is indicated, as can be observed in lotus plants. The cause of the lotus effect lies in a particular surface structure, which creates such a low adhesion force that the cohesion forces even within a liquid with a lower surface tension outweigh the adhesion forces and therefore no wetting of the surface results. Micro, nano-structured, superhydrophobic surfaces are required to reproduce this effect.

The planned waste water repository serves as a receptacle for the used fluids needed for the different wash cycles in the cleaning unit. The waste water repository has the advantage of being easily removable from the device, or at least easily emptied, and it is ideally designed so that it can hold the liquid contents that are produced during at least one day's use.

In a particularly preferential version of the invention, one initial liquid reservoir is provided for cleaning fluids, such as distilled water, and a second holder is provided for disinfectants, such as one containing H₂O₂, NaOH or NaOCl, whereby the volume from the first holder, from the second and the volume from the waste water repository corresponds to a ratio of 2:1:3. The volume the waste water repository can hold is preferably at least that of the cleaning and disinfectant liquids required per day.

As already explained above, in the liquid reservoirs the required liquids are provided for the individual wash cycles of the cleaning program. In principle, for a wash cycle only one liquid from the liquid reservoir fills the cleaning unit. For certain wash cycle applications it is however possible to fill the cleaning unit with a mix of liquids from more than one liquid reservoir. The liquid in the cleaning unit at the end of the wash cycle is typically emptied into the waste water repository. This means that the used liquid in the cleaning unit cannot be re-used for another wash.

To reduce liquid consumption, at least for one or more types of liquid, in another particularly beneficial design of the device according to the invention, one or more closed fluid circuits, each with a liquid filter system, are provided. With a closed fluid circuit of this type, the required liquid from the respective reservoir fills the cleaning unit for a wash cycle, and after its use in the cleaning unit it is fed via a liquid filter system back to the liquid reservoir. This makes it possible for used, soiled liquid in the cleaning unit to be salvaged and to be available for re-use in the corresponding liquid reservoir. The filter system is ideally designed to make it easily accessible and, therefore, easily replaceable.

The liquid reservoirs, the cleaning unit and the waste water repository are typically interconnected through the fluid conduits accordingly, for example, through hose lines or metal flumes. The liquid is conveyed through the fluid conduits, in the simplest case, by means of hydrostatic pressure applied to the fluids. For this purpose, the liquid reservoir's is situated above the cleaning unit and the waste water repository below. This ensures that the filling and emptying of the cleaning unit is feasible solely due to the hydrostatic pressure applied to the liquids. Alternatively, or additionally, one or more liquid pumps and/or compressors can be provided, which are connected to and controlled by the control unit. These at least ensure that liquid from the liquid reservoirs can be actively pumped into, or out of, the cleaning unit.

To control the liquid flow, the device according to the invention comprises one or more switches, which are connected to the control unit and allow a minimum control of the flow of liquid from the reservoirs into the cleaning unit, as well as the draining of liquid from the cleaning unit. Above all, these ensure that these filling and draining processes can be switched (shut off), if required. It is an added advantage if all switches are valves, in particular magnetic valves.

Moreover, the device of the invention comprises a support mechanism for the wash cycles as well as the drying cycles. These mechanisms improve the effectiveness, in other words the efficacy, and/or efficiency, or rather cost-optimization, of the respective processes. As a support mechanism for the wash cycle, fundamentally the appropriate mechanism is used to improve and/or optimize the outlay of the washing cycle. The same applies to the drying cycle support mechanism. Furthermore, it is conceivable to use a mechanism that can support both the wash and drying cycles.

One particularly advantageous design variant of the device of the invention provides a support mechanism for the wash cycle and/or the drying cycle, which is connected to the control unit. The control unit then controls a second propulsion means, preferably an electric motor, which can rotate along the longitudinal axis at least one of the optic gauges placed in the receptacle. By rotating, at least partially, an optic gauge immersed in the liquid of the cleaning unit along its longitudinal axis, the number of the optic gauge's immersed surfaces coming into contact with the liquid molecules per unit time is increased, and therefore the washing process is assisted. The results from analysis of different optic gauges suggest that rotational speeds of <500 rpm are particularly suitable, preferably 25-250 rpm. By rotating the optic gauges the liquid itself also rotates, which reduces the abovementioned supportive effect due to the lower relative speed of the liquid and the gauge's surfaces. As a result, the rotational direction of the gauge along its longitudinal axis is switched during the washing process at specific intervals, as an added advantage.

Moreover, the second propulsion means provides support for the drying process, as the optic gauges are rotated at such a rotational speed along their longitudinal axis to ensure that any remaining liquid residue (such as drops) are removed by the centrifugal force of the rotation from the optic gauge, and particularly from the eye surface contact area. Ideally, the optic gauges should have a rotation speed of >300 rpm, ideally 600-1000 rpm along their longitudinal axis.

An alternative, or additional, support mechanism for the wash cycle is the provision of at least one ultrasonic transducer, which is compatible with the control unit, where the liquid ultrasonic waves in the cleaning unit can be coupled. The existing ultrasonic fields in the liquid generate waves with high and low pressure. If such a low pressure wave hits the optic gauges being washed, they form small, air bubbles acting on germs with steam filled cavities. When the following high pressure wave strikes the cavity, the static pressure in the cavity increases through its compression once again over its saturated vapour pressure. Thus, the vapour bubbles condense abruptly with the speed of sound. The pressure peaks rise up to 100,000 bar. These cyclically rising and falling cavities work on the liquid-immersed surfaces of the optic gauge and clean them. Dirt and other adhesions are gently and mechanically removed.

A further alternative, or additional, support mechanism for the wash cycle can be provided in the form of a mixer in the cleaning unit, where the liquid in the cleaning unit is moved around. The support produced for the cleaning effect is explained, as above, by rotating the optic gauge along its longitudinal axis, through increasing the number of immersed surfaces of the optic gauge that come into contact with liquid molecules per unit time. In an advanced embodiment, the mixer is designed as a propeller, which is arranged in the bottom area of the cleaning unit. The propeller is rotatable supported around a horizontal axis of rotation, i.e. in case of a rotation-symmetrical cleaning unit the axis of rotation is aligned perpendicular to said axis of symmetry. For driving the propeller an electric motor is connected at one end of a shaft. The propeller is joined at the other end of the shaft. Due to propeller rotation, flow swirls are induced into the cleaning liquid which support the cleaning process and which further prevent air bubbles from accumulating at concave shaped surfaces of the optic gauge facing down.

A further alternative, or additional, support mechanism for the wash cycle and/or drying cycle can be provided in the form of a heating element in the cleaning unit, where the liquid or air in the cleaning unit is heated. Through heating, the temperature of the liquid in the cleaning unit is increased, which in turn increases the number of the immersed optic gauge's surfaces coming into contact with liquid molecules per unit time and thereby assists the wash process. During a drying cycle, the heating element can also warm the air inside the cleaning unit, which can lead to an increase in the evaporation rate of liquid residues present on the surfaces of the optic gauge inserted into the cleaning unit.

A further alternative, or additional, support mechanism for the drying cycle can be provided in the form of a fan, to ensure the optic gauge, and particularly its eye surface contact area, is dryable.

As stated above, a control unit is provided to control the whole cleaning process, which can at least be connected to the washing and drying support mechanisms. These mechanisms can be automatically controlled via the control unit, as per a fixed, pre-set or variable specific cleaning program. An advantage here is that the device can be provided with an input unit connected to the control unit, where the parameters concerning the cleaning program are specified. This input unit can, for example, be an external computer, which is connected to the control unit via a control unit interface. For recording the cleaning processes carried out, a module for setting up a cleaning cycle can be provided, as well as an output unit, via which at least the cleaning cycle can be output. The cleaning programme can be started ideally by manual entry or operation of a starting unit, such as a switch etc., connected to the control unit.

In addition, ideally at least one filling level probe is provided on the cleaning unit, connectable to the control unit, which allows determination of whether at least one minimum pre-set target filling level set for each cleaning unit has been reached. Moreover, one filling level probe is provided on the liquid reservoirs, which is connectable to the control unit, so that achievement of a minimum of at least one pre-set target filling level in each case can be determined. Furthermore, a minimum of one filling level probe can be provided on the waste water repository, connected to the control unit, which can monitor the achievement of at least one pre-set maximum liquid filling level in the waste water repository. In addition, a visual and/or acoustic alarm can be provided, where an alarm is triggered once a minimum or maximum level of liquid has been reached. Moreover, once this alarm has been triggered the program sequence can be stopped or actually not put into operation at all.

The following will indicate the operating method of the device, which comprises the following steps. Step one is allocating a cleaning program in the control unit, whereby the cleaning program determines a sequence of wash cycles and drying cycles. Step two manually places at least one optic gauge into the receptacle. Step three, if the receptacle is not fixed, makes sure that the optic gauge placed into the receptacle from above, with the eye surface contact area inserted first, extends into the cleaning unit at a depth, and that the corresponding positioning of the receptacle and/or the cleaning unit are relative to each other. Step four is starting the cleaning program. Step five automatically runs the wash and drying cycles according to the cleaning programme's sequence and cleaning parameters.

At the end of step five, the cleaning of the optic gauge is finished and the sixth step is to remove it from the receptacle. Alternatively, the clean optic gauges can remain in the device to be stored safely until they are next used.

A particularly favourable variation of this method is that the optic gauge projects out of the receptacle during the whole cleaning program, unaltered at the same target depth in the cleaning unit. This simplifies the construction technically. Alternatively, the procedure is adaptable by which the optic gauge during the drying process, for example, is removed from the cleaning unit.

In the cleaning program, each wash cycle is primarily defined by parameters, which determine the liquids to be used and/or the liquid reservoirs in which the liquid is stocked for the respective wash process, the target length of wash cycle, or during the wash cycle the means to be activated to support the wash process. Furthermore, primarily all drying cycles are defined by parameters in the cleaning program, which determine the target length of the drying cycle, for the particular drying cycles, and the support mechanism to be activated during the drying process.

Primarily, for every wash cycle, the following minimum steps will be followed. Step one, filling the cleaning unit up to the specified target level with the liquid from the liquid reservoir defined by the respective wash cycle in the cleaning program. After the unit is filled, the optic gauges with the eye surface contact area inserted first have a target immersion depth in the liquid contained in the cleaning unit. Step two, according to the respective definition in the cleaning program, one or more of the wash cycle support mechanisms is activated. Step three, after the cleaning program's specified target wash cycle has ended, the liquid shall be emptied from the cleaning unit into the waste water repository or it shall be transferred back to the liquid reservoirs via a filter system, from which the preceding filling of the cleaning unit occurs.

Primarily, for every drying process, the minimum following steps are followed. As set by the cleaning program, one or more of the support mechanisms for the drying cycles is activated for a target length of time specified by the cleaning program.

Primarily, the cleaning unit is filled with a liquid, which is identical in terms of immersion depth, regardless of the type of optic gauge being cleaned. This can technically be implemented so that every optic gauge inserted from above, with the eye surface contact area inserted first, sits at the same target depth in the cleaning unit, and the amount of liquid dispensed into the cleaning unit is measured out in such a way that a specified, target depth customized target filling level is reached in the cleaning unit. Reaching the target filling level can, in turn, be achieved using a filling level probe.

In principle, the sequence of the wash and drying cycles in the cleaning program is arbitrary. In this way, two wash cycles could follow one another with different liquids, before the drying cycle. However, it is particularly advantageous to provide a drying cycle at the end of the cleaning program's sequence.

All in all, the device of the invention permits a gentle, cost-effective, automatic and controlled cleaning of optic gauges, particularly tonometer gauges and ophthalmic contact lenses. To clean ophthalmic contact lenses, the cleaning program must include changeable times for wash cycles, to make sure that, depending on the liquid used, the ophthalmic contact lenses are not immersed for too long, as the putty sections of the ophthalmic contact lenses can be damaged. The device's liquid consumption can be reduced by means of a cleaning unit designed for a reduced volume to save on cleaning and disinfectant liquids. Standards-compliant cleaning programs can be simply implemented by means of a changeable, typically software-based cleaning program. The device of the invention can comprise suitable displays to ensure that the duration of the wash and drying cycles can be monitored. Furthermore, internal test and checking circuits can be arranged in the device, which constantly monitor the device's functionality and the correct running of the specific cleaning program. If problems should arise, this could generate a visual or acoustic alarm or lead to other specific remedial measures. The device also operates independently of a water supply through a water pipe. The device can also operate in a fully self-contained manner with battery power. Through the corresponding dimensions of the liquid reservoirs and the waste water repository, a daily amount of liquid (for example, approx. 20-30 cleanings of tonometer gauges in an optician's practice) can be held and processed in the device, without having to refill the liquid reservoirs or empty the waste water repository.

### BRIEF DESCRIPTION OF THE DRAWINGS

The invention will be described with examples as follows, without restriction on the general concepts of the invention and making reference to a design example.

FIG. 1 is a view of prior art applanation tonometry with a patient;

FIG. 2 is a view of the implementation of prior art diagnostic treatment with an ophthalmic contact lens;

FIG. 3 a is a microscopic picture of surfaces of a new prior art tonometer gauge;

FIG. 3 b is a microscopic picture of surfaces of a prior art tonometer gauge which has been used for two years and cleaned according to a specific cleaning procedure;

FIG. 4 is a schematized construction of the device according to the invention; and

FIGS. 5a and b are longitudinal sectional views through the receptacle according to the invention containing the optical gauge and a mixer designed as a propeller.

### DETAILED DESCRIPTION OF THE INVENTION

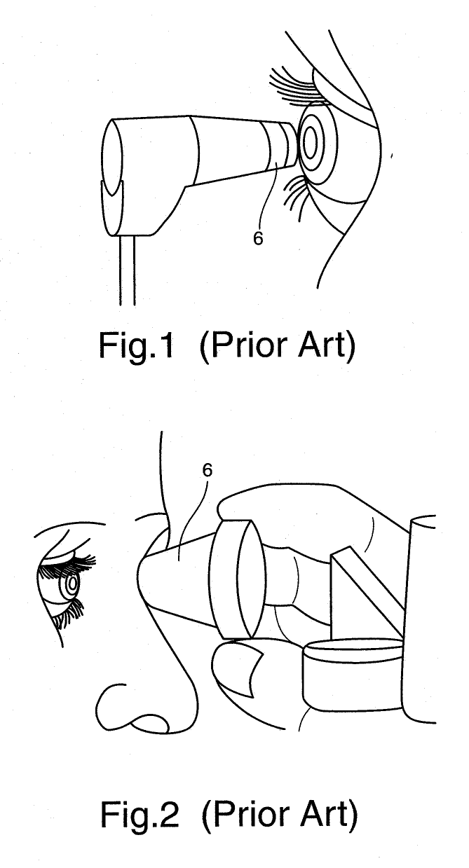

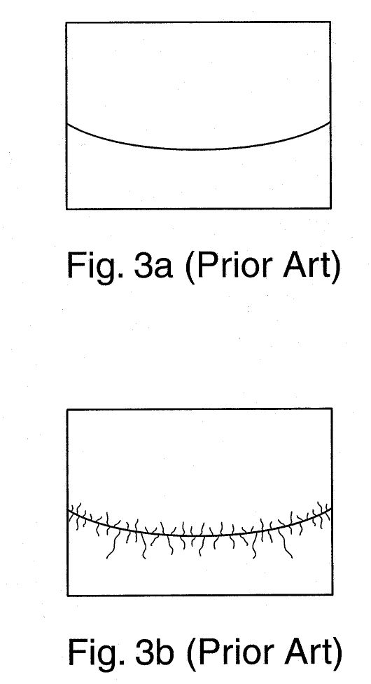

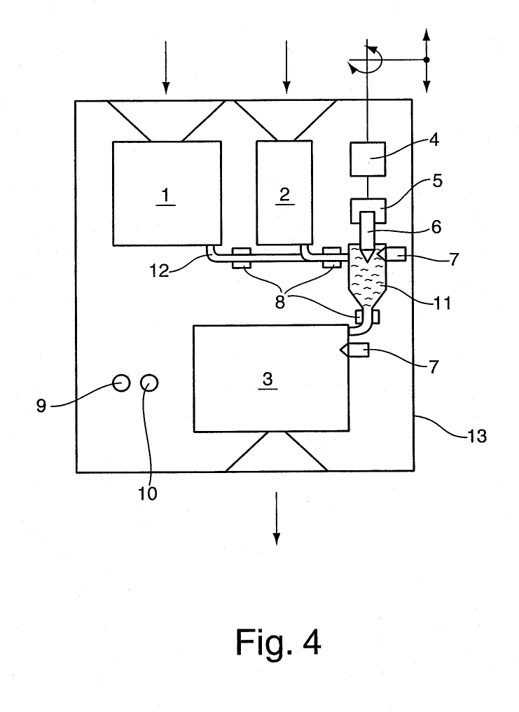

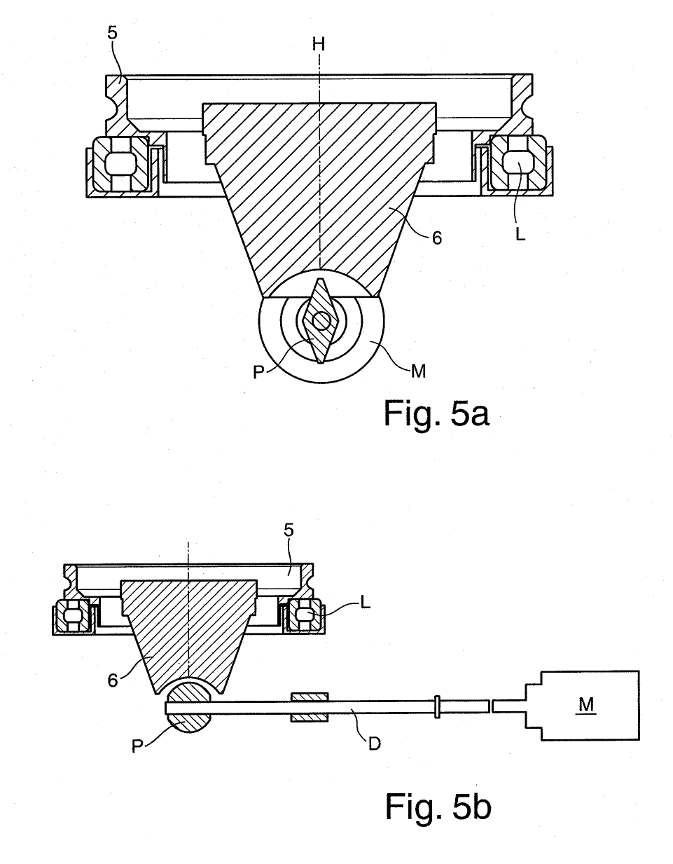

FIGS. 1-3 b illustrate the state of the art and have already been explained in the above and therefore, at this stage, reference will be made to FIG. 4 and FIGS. 5a and b.

FIG. 4 shows a schematized construction of the device of the invention for cleaning optic gauges, which have an eye surface contact area. The optic gauge placed in the device's receptacle (5) to be cleaned is the tonometer gauge (6). The device is also suitable in particular for cleaning ophthalmic contact lenses, which can be placed in receptacle (5) instead of the tonometer gauge.

The device comprises two liquid reservoirs (1, 2) which are connected to the cleaning unit (11) via hose lines (12), a waste water repository (3) connected to the cleaning unit (11) via hose lines, a receptacle (5) with the tonometer gauge (6) placed inside, as well as a second propulsion unit (4), which rotates the receptacle (5) holding the tonometer gauge (6) along a rotation axis which corresponds to the longitudinal axis of the tonometer gauge (6). The cleaning unit (11) is cylindrical, equipped with a downwardly tapered conical floor surface. At the deepest point of the floor surface there is an outlet opening, which connects to the waste water repository (3). The cleaning unit (11) is also coated with lotus effect surfaces, so that the liquid contained in the cleaning unit can be easily and completely emptied. The liquid reservoirs (1, 2) are positioned above the cleaning unit (11), and this is, in turn, placed above the waste water repository (3). This allows for filling of the cleaning unit (11) with liquid from the liquid reservoirs (1, 2) and emptying of the fluid in the cleaning unit (11) into the waste water repository (3) without additional pumps which is possible solely due to the hydrostatic pressure differences. The device has housing (13) with funnel-shaped openings (each marked with vertical arrows) intended to supply, or fill, the liquid reservoirs (1, 2) with liquid and to empty the waste water repository. Switchable magnetic valves (8) are also provided to control the supply of liquids from the liquid reservoirs (1, 2) to the cleaning unit (11), as well as emptying the cleaning unit (11). The device also includes two filling level probes (7), with one attached to the cleaning unit (11) to detect when the target filling level has been reached, and one filling level probe (7) attached to the waste water repository (3) to detect when the maximum level in the repository has been reached. The filling level probes used for this purpose are known to specialists. They can be based on visual, electric or mechanical operating principles, or a combination of the above. Finally, there are two light-emitting diodes (LEDs) (9, 10) on the housing which display the device status. To display the device status almost all well-known specialist alternatives are feasible, therefore their description can be foregone here. In this case, an initial green light-emitting diode (9) is provided, which flashes during the automatic, uninterrupted running of the cleaning program and shines constantly at the end of the cleaning program. There is also a red light-emitting diode (10) present, which lights up if a fault is detected during the automatic cycle of a cleaning programme, or if the maximum filling level has been reached in the waste water repository.

The first propulsion means is not displayed here, which positions the receptacle (5) relative to the cleaning unit (11) so that a tonometer gauge (6) placed from above into the receptacle (5), with the eye surface contact area inserted first, can be at least partially immersed in the cleaning unit (11) and can be lifted upwards out of the cleaning unit (11). The insertion and removal of the tonometer gauge (6) into the receptacle (5) occurs with the receptacle (5) vertically positioned above the cleaning unit (11), to ensure that the tonometer gauge (6) can be easily inserted/removed manually in and out of the receptacle (5), without touching the eye surface contact area of the tonometer gauge (6).

The first propulsion means could be a manually operated lever mechanism or an electric motor, particularly a linear motor. Of course there are a vast number of alternative, specialist mechanisms that are possible, which allow for simple, manual insertion or removal of a tonometer gauge (6) into/out of the receptacle (5) as well as at least a partial insertion of the tonometer gauge in the receptacle (5) into the cleaning unit. For example, the receptacle could be mounted on a swivel arm that can be swiveled upwards for the insertion and removal of the tonometer gauge and moved into a position during cleaning to immerse the tonometer gauge in the cleaning unit.

In another alternative design, the receptacle (5) does not require the first propulsion means. In this design the receptacle (5) is in a fixed position relative to the cleaning unit (11), so that the tonometer gauge (6) is placed from above into the fixed receptacle and it then extends into the cleaning unit (11).

FIG. 4 also does not illustrate a control unit, which, as a minimum, is connected electrically to the valves (8), the first propulsion means (if applicable), the second propulsion means (4), the filling level probes (7) and the LEDs (9, 10) and through which a specific cleaning program can be automatically operated. As stated above, the cleaning program determines a sequence of wash and drying cycles, where the specific characteristics of the individual wash and drying cycles are defined according to parameters of that cleaning program.

FIGS. 5 a and b show longitudinal section views through a tonometer gauge 6, which is placed in a receptacle 5 being rotatable mounted at a bearing L around the vertical axis H. The bearing L is not connected with the illustrated cleaning unit. It is assumed that the tonometer gauge 6 is arranged inside the cleaning unit which is filled with cleaning liquid. A propeller P is arranged within the cleaning unit. The propeller P is connected to a shaft D which is driven by an electric motor M. The propeller is arranged directly below the concave shaped surface of the tonometer gauge 6 which is directed downwardly. Thus accumulation of air bubbles below this concave contour of the gauge 6 is avoided.

The present design example of the device of the invention for cleaning optic gauges will ideally operate with a cleaning program which has an initial wash cycle running sequence, with the following parameters:
Use of a cleansing fluid, such as distilled water,
Length of wash cycle: >preferably 30-180 s, and
Rotation of the optic gauge along its symmetrical axis at <500 rpm and turning in alternating directions,
   A first drying cycle with the following parameters:
Length of the drying cycle: >5 s, preferably 10-60 s and
Rotation of the optic gauge along its symmetrical axis at >300 rpm,
   A second wash cycle with the following parameters:
Use of a disinfectant liquid, such as 3% hydrogen peroxide,
Length of the wash cycle: >1 min, preferably 5-10 min and
Rotation of the optic gauge along its symmetrical axis at <500 rpm and turning in alternating directions,
   A second drying cycle with the following parameters:
Length of the drying cycle: >5 s, preferably 10-60 s and
Rotation of the optic gauge along its symmetrical axis at >300 rpm,
   A third wash cycle with the following parameters:
Use of a cleansing fluid, such as distilled water,
Length of the wash cycle: >2 min, preferably 10-60 min and
Rotation of the optic gauge along its symmetrical axis at <500 rpm and turning in alternating directions, and
   A third drying cycle with the following parameters:
Length of the drying cycle: >5 s, preferably 10-60 s, and
Rotation of the optic gauge along its symmetrical axis at >300 rpm.

### KEY TO REFERENCE NUMBERS

1 Liquid reservoir (such as for distilled water)
2 Liquid reservoir (such as for 3% hydrogen peroxide)
3 Waste water repository
4, 4a, 4b Support mechanism for the wash cycle (4a) and support mechanism for the drying cycle (4b) are identical in the present design example: (4)=(4a)=(4b): propulsion means (such as an electric motor), mechanism to rotate the optic gauge along its longitudinal axis
5 Receptacle
6 Optic gauges, such as tonometer gauges, ophthalmic contact lenses
7 Filling level probe (visual, electric, etc.)
8 Switches, valve, magnetic valve
9, 10 LED display
11 Cleaning unit
12 Hose lines
13 Housing

1. A device for cleaning at least one optic gauge, which have an eye surface contact area, comprising:
a liquid filling and emptying top-opening cleaning unit;
at least one liquid reservoir, connectable to the cleaning unit, for permitting fluids contained in the at least one liquid reservoir to be dispensed into the cleaning unit;
a waste water repository, connectable to the cleaning unit, for permitting liquid to be drained from the cleaning unit into the waste water repository;
a receptacle for holding at least one optic gauge, that is either in a fixed position or positionable so that an optic gauge, inserted into the receptacle from above with an eye surface contact area being first, at least partially projects into the cleaning unit;
at least one switch for influencing flow of liquid from the at least one liquid reservoir into the cleaning unit and/or out of the cleaning unit;
a mechanism providing a wash cycle;
a mechanism providing a drying cycle; and
a control unit, coupled to the at least one switch, the mechanism providing a wash cycle and the mechanism providing a drying cycle which provides automatic program control of cleaning of the at least one optic gauge; and
a propulsion means, provided with the mechanism providing the wash cycle and/or the mechanism providing the drying cycle, which is coupled to and controlled by the control unit and comprises an electric motor, for rotating the at least one optic gauge in the receptacle around a rotational axis.

2. A device according to claim 1, comprising:
a propulsion means, when the receptacle and/or the cleaning unit are positioned relative to each other, for providing the at least one optic gauge being at least partially inserted into the cleaning unit and being removed from the cleaning unit from above.

3. A device according to claim 2, wherein:
the propulsion means comprises a mechanically operated lever unit, an electric motor or a linear motor.

4. A device according to claim 1, comprising:
a start unit connected to the control unit for starting a cleaning program.

5. A device according to claim 1, wherein:
surfaces of the at least one gauge which is contacted by the liquid in the cleaning unit exhibits a lotus effect.

6. A device according to claim 1, wherein:
the cleaning unit is rotationally symmetrical.

7. A device according to claim 1, wherein:
the cleaning unit comprises a funnel-shaped floor surface, which at a deepest point of the floor includes an opening through which the fluid remaining in the cleaning unit can be emptied.

8. A device according to claim 1, comprising:
at least one liquid pump and/or compressor which are coupled to and are controllable by the control unit, through which liquids can be pumped from the at least one liquid reservoir into the cleaning unit and/or out of the liquid reservoir.

9. A device according to claim 1, wherein:
the switches are valves or magnetic valves.

10. A device according to claim 1, wherein:
the cleaning unit comprises a filling level probe connectable to the control unit, which at least detects when a target level has been reached in the cleaning unit.

11. A device according to claim 1, comprising:
at least one filling level probe on one of the at least one liquid reservoir, which is connectable to the control unit, for detecting when a minimum level has been reached in the one liquid reservoir.

12. A device according to claim 1, comprising:
at least one filling level probe on the waste water repository, connectable to the control unit, for detecting when a maximum level has been reached in the waste water repository.

13. A device according to claim 11, comprising:
a visual and/or acoustic alarm, which is triggered once the minimum level of liquid has been reached.

14. A device according to claim 13, wherein:
the at least one liquid reservoir is above the cleaning unit and the waste water repository is below the cleaning unit so that filling and emptying of the cleaning unit occurs due to the hydrostatic pressure on the liquids.

15. A device according to claim 14, wherein:
the at least one liquid reservoir contains cleaning fluids and a second liquid reservoir contains disinfectant wherein a volume from a first liquid reservoir and volume from a second liquid reservoir and volume from the waste water repository have an approximate ratio of 2:1:3.

16. A device according to claim 15, comprising:
at least one closed fluid circuit, each fluid circuit including at least a fluid filter system so that fluid from the at least one liquid reservoir is dispensed to the cleaning unit in one of the at least one closed fluid circuit, and after use can be supplied back to the at least one liquid reservoir from the cleaning unit through the at least one fluid filter system.

17. A device according to claim 16, wherein:
the at least one fluid filter system comprises replaceable filters.

18. A device according to claim 17, comprising:
at least one adapter including a receptacle for holding optic gauges of different shapes therein.

19. A device according to claim 18, comprising:
an adapter integrated including a receptacle for holding optic gauges.

20. A device according to claim 19, wherein:
the optic gauges are rotated during the wash cycle, at a rotation speed of <500 rpm, and are rotated during the drying cycle at a rotation speed of >300 rpm, along the rotational axis.

21. A device according to claim 1, wherein:
the propulsion means provided with the drying cycle provides two rotational directions of the optic gauges along a longitudinal axis thereof.

22. A device according to claim 21, comprising:
at least one ultrasonic transducer for the wash cycle in the cleaning unit for connection to the control unit for the wash cycle which couples the fluid contained in the cleaning unit to ultrasonic waves.

23. A device according to claim 1, comprising:
a mixer in the cleaning unit for moving the fluid in the cleaning unit during the wash cycle.

24. A device according to claim 23, comprising:
a heating element in the cleaning unit, associated with the wash cycle and/or the drying cycle, for heating the liquid or air contained in the cleaning unit.

25. A device according to claim 24, comprising:
a fan for drying the optic gauge including the eye surface contact area during the drying cycle.

26. A device according to claim 25, comprising:
an input unit, connected to the control unit, for specifying parameters of the program.

27. A device in accordance with claim 26, wherein:
the input unit is an external computer which is connected to the control unit by a control unit interface.

28. A device in accordance with claim 27, comprising:
a module for providing a cleaning record including an output unit for displaying the cleaning record.

29. In a device for cleaning optic gauges, which have an eye surface contact area, including a liquid filling and emptying top-opening cleaning unit, at least one liquid reservoir, connectable to the cleaning unit, for permitting fluids contained in the at least one liquid reservoir to be dispensed into the cleaning unit, a waste water repository, connectable to the cleaning unit, for permitting liquid to be drained from the cleaning unit into the waste water repository, a receptacle for holding at least one optic gauge, that is either in a fixed position or positionable so that an optic gauge, inserted into the receptacle from above with an eye surface contact area being first, at least partially projects into the cleaning unit, at least one switch, for influencing the flow of liquid from the at least one liquid reservoir into the cleaning unit and/or out of the cleaning unit, a mechanism providing a wash cycle, a mechanism providing a drying cycle, and a control unit, coupled to the at least one switch, the mechanism providing a wash cycle and the mechanism providing a drying cycle, which provides automatic program control of cleaning of the optic gauges; and a propulsion means, provided with the mechanism providing the wash cycle and/or the mechanism providing the drying cycle, which is coupled to and controlled by the control unit and comprises an electric motor, for rotating at least one optic gauge in the receptacle around a rotational axis, a method of cleaning the at least one optic gauge comprising:
a) selecting a program in the control unit, which at least determines a sequence of wash cycles and drying cycles;
b) manually inserting at least one optic gauge into the receptacle;
c) if the receptacle is not in a fixed position, providing an optic gauge placed in the receptacle from above, with the eye surface contact area first, at a depth in the cleaning unit, and positioning the receptacle and/or the cleaning unit relative to each other;
d) starting the program to clean the at least one optic gauge; and
e) automatically washing and drying the at least one optic gauge; and wherein
each wash cycle is defined by parameters, which at least determine liquids to be used and/or the at least one liquid reservoir in which the liquid is stored for washing cycles, a length of each washing cycle, and the mechanisms to be activated during each washing cycle and each drying cycle are defined by parameters in the program which determine length of the washing and drying cycles and the mechanisms to be activated during each washing and drying cycle.

30. A method in accordance with claim 29, comprising:
removing the at least one optic gauge from the receptacle.

31. A method in accordance with claim 29, comprising:
positioning the at least one optic gauge to project out of the receptacle during all of the program at a constant depth in the cleaning unit.

32. A method in accordance with claim 29, comprising:
for every wash cycle filling the cleaning unit up to a specified level with liquid from the at least one liquid reservoir defined by a washing cycle in the program, placing the at least one optic gauge with the eye surface contact area being inserted first, at an immersion depth in the liquid contained in the cleaning unit;
according to the program activating at least one mechanism during the washing cycle; and
after the washing cycle has ended, emptying liquid from the cleaning unit into the waste water repository or transferring the liquid from the washing cycle back to the at least one liquid reservoir via a filter system, from which a preceding filling of the cleaning unit occurred.

33. A method in accordance with claim 29, wherein:
the drying cycle is started with a specified length; and
according to the program, at least one of the mechanisms associated with the drying cycles is activated for the specified length.

34. A method in accordance with claim 32, wherein:
an amount of liquid dispensed into the cleaning unit is measured to provide an immersion depth which is identical for every wash cycle regardless of the at least one optic gauge being cleaned.

35. A method in accordance with claim 29, wherein:
the cleaning program ends with a drying cycle.
